(19) United States
(12) Patent Application Publication
(10) Pub. No.: US 2018/0364871 A1
(43) Pub. Date: Dec. 20, 2018

(54) AUTOMATIC COGNITIVE ADJUSTMENT OF DISPLAY CONTENT

(71) Applicant: INTERNATIONAL BUSINESS MACHINES CORPORATION, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN)

(21) Appl. No.: 15/627,763

(22) Filed: Jun. 20, 2017

(51) Int. Cl. G06F 3/0481; G06F 9/44; G06N 5/02

(52) U.S. Cl. CPC G06F 3/0481; G06F 17/30; G06N 5/025; G06F 9/4443

(57) ABSTRACT

Systems and methods for automatic cognitive adjustment of display content are disclosed. In embodiments, a computer-implemented method includes: displaying on a display a first configuration of elements from a group of elements configured to be displayed on the computing device based on starting state rules; receiving real-time event data from one or more remote data sources, wherein the real-time event data is associated with one or more categories of interest to a user; accessing user interest data prioritizing the categories of interest to the user; determining a temporary second configuration of elements from the group of elements based on the starting state rules, the real-time event data and the user interest data; and automatically updating the display to display the second configuration of elements, wherein the temporary second configuration of elements is different from the first configuration of elements.

### BACKGROUND

The present invention relates generally to configuring elements on a display, and more particularly, to automatic cognitive adjustment of display content.

Mobile computing devices are increasingly used on a continuous basis. Such mobile devices may have relatively small display screens capable of displaying only a limited amount of information (e.g., apps, widgets, notifications, icons, etc.). Various methods have been developed to organize information on a display screen of a computing device, including user selected positioning of apps (icons representing apps) and the like via drag and drop methods. Other methods enable positioning of apps on a display of a computing device based on a priority assigned to the apps. Additionally, a variety of methods have been developed for changing the style of the display screen (e.g., lighting, coloring, style of displayed icons, apps, widgets, etc.), including user-implemented selection of display screen styles using control options of a computing device. Developers continue to look for ways to increase the functionality of display screens and to improve the look, feel, and usefulness of display screens, particularly in the field of mobile computing devices.

### SUMMARY

In an aspect of the invention, a computer-implemented method includes: displaying on a display, by a computing device, a first configuration of elements from a group of elements configured to be displayed on the computing device based on starting state rules; receiving, by the computing device, real-time event data from one or more remote data sources, wherein the real-time event data is associated with one or more categories of interest to a user; accessing, by the computing device, user interest data prioritizing the categories of interest to the user; determining, by the computing device, a temporary second configuration of elements from the group of elements based on the starting state rules, the real-time event data and the user interest data; and automatically updating, by the computing device, the display to display the second configuration of elements, wherein the temporary second configuration of elements is different from the first configuration of elements.

In another aspect of the invention, there is a computer program product for automatic cognitive adjustment of display content. The computer program product includes a computer readable storage medium having program instructions embodied therewith. The program instructions are executable by a computing device to cause the computing device to: receive starting state rules for a group of elements configured to be displayed by the computing device; display, on a display screen, a first configuration of elements from the group of elements based on the starting state rules; receive real-time event data from one or more remote data sources, wherein the real-time event data is associated with one or more categories of interest to a user; access user interest data at a remote server, wherein the user interest data prioritizes the categories of interest to the user; determine a temporary second configuration of elements from the group of elements based on the starting state rules, the real-time event data and the user interest data; and automatically update the display screen to display the second configuration of elements, wherein the temporary second configuration of elements is different from the first configuration of elements.

In another aspect of the invention, there is a system for automatic cognitive adjustment of display content. The system includes a CPU, a computer readable memory and a computer readable storage medium associated with a computing device; program instructions to display, on a display screen of the computing device, a first configuration of elements based on starting state rules; program instructions to receive real-time event data from one or more remote data sources, wherein the real-time event data is associated with one or more categories of interest to a user; program instructions to access user interest data, wherein the user interest data prioritizes the categories of interest to the user; program instructions to determine a temporary second configuration of elements based on the starting state rules, the real-time event data and the user interest data; and program instructions to automatically update the display screen to temporarily display the second configuration of elements until a predetermined threshold event is met, wherein the temporary second configuration of elements is different from the first configuration of elements; wherein the program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computing infrastructure according to an embodiment of the present invention.

FIG. 2 shows an exemplary environment in accordance with aspects of the invention.

FIG. 3 shows a flowchart of steps of a method in accordance with aspects of the invention.

FIGS. 4A and 4B illustrate a particular use scenario in accordance with embodiments of the invention.

FIG. 5 shows a flowchart of steps of a method in accordance with aspects of the invention.

### DETAILED DESCRIPTION

The present invention relates generally to configuring elements on a display, and more particularly, to automatic cognitive adjustment of display content. In embodiments, a system is provided for real-time automatic adjustment of shown elements (e.g., widgets, apps, icons or information) on a given user's device, such as a smartphone, smartwatch, laptop, tablet and the like. In aspects, methods of the invention render and arrange highest priority elements on a given screen based on: an initial configuration; discovered user interest levels; and real-time event data regarding events that the user may or may not be aware of, but has an interest in. Real-time event data may include, for example, meteorological or weather data, traffic data, news data, sports data, airline or other travel data, etc. A user may be unaware of certain events taking place that the user would have a high interest in knowing about. As these events happen, elements on a device display may be temporarily replaced or otherwise rearranged according to the desired configuration of the user. Thus, embodiments of the invention provide the dynamic capability to understand events in the world, understand the importance of the events to a user, and take action to adjust how elements are displayed. Additionally, aspects of the invention allow for self-learning and the capability to adjust priority levels of certain events that a user is more interested in as determined by the system reading through streams of data received from social sites of the user or other communication data sources.

Advantageously, embodiments of the invention improve the function of computing devices, particularly mobile computing devices with limited display screen sizes, by enabling the computing device to automatically reconfigure display elements (e.g., apps, widgets, icons, etc.) based on interests of the user and real-time event data received by the computing device. The reconfiguring of display elements may be temporary. Moreover, embodiments of the invention reduce computational loads of the computing device by proving user interest data determined at a remote server utilizing multiple streaming sources of context data (e.g., emails, text messages, social media posts, etc.). Aspects of the invention also improve the function of the computing device by adding automatic display reconfiguration functionality to reconfigure the display in real-time based on the user's surrounding environment (e.g., movie theatre, sunny beach, etc.).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

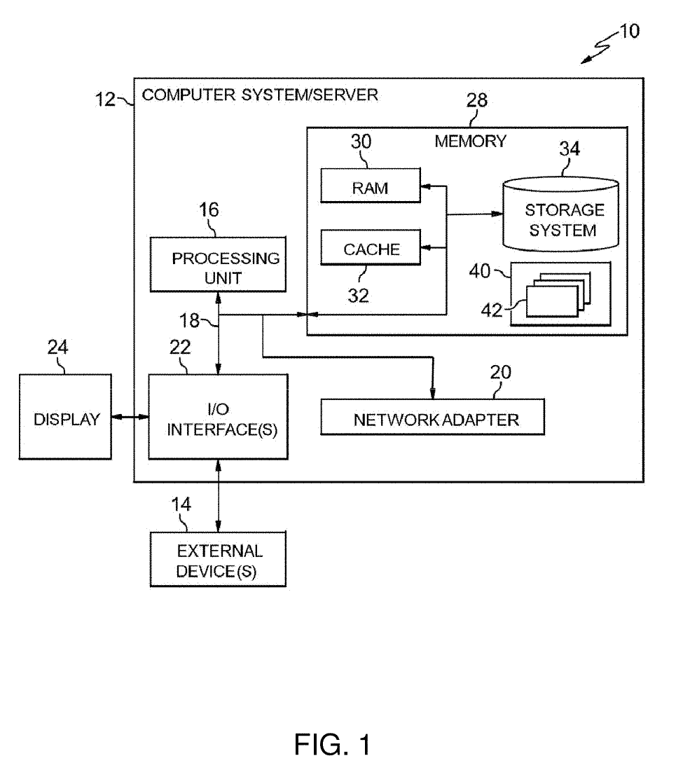

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

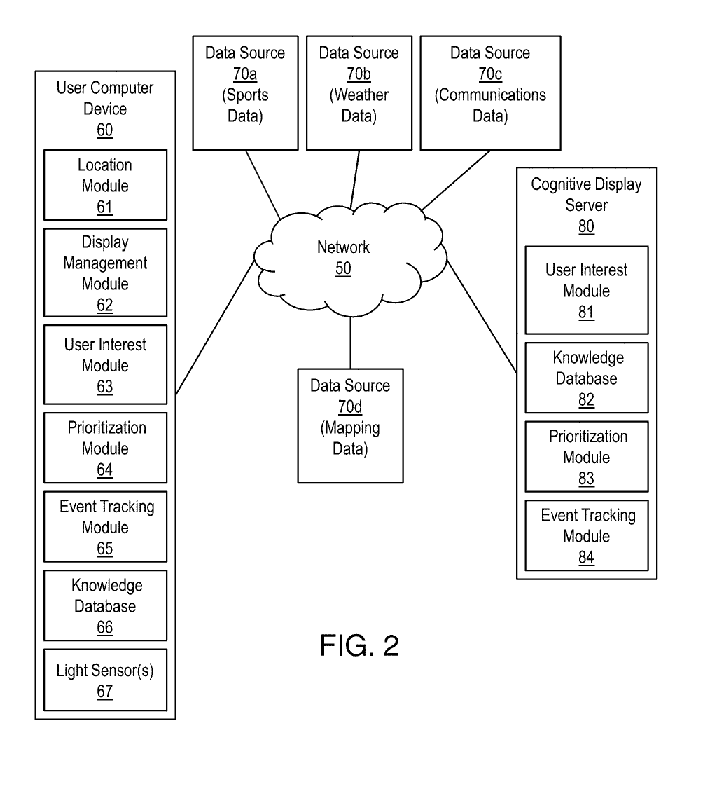

FIG. 2 shows an exemplary environment in accordance with aspects of the invention. The environment includes a user computer device 60 connected to a network 50. The user computer device 60 may comprise a computer system 12 of FIG. 1, and may be connected to the network 50 via the network adapter 20 of FIG. 1. The user computer device 60 may be a desktop computer, a laptop computer, a tablet computer, a smartwatch, a smartphone, etc.

The network 50 may be any suitable communication network or combination of networks, such as a local area network (LAN), a general wide area network (WAN), and/or a public network (e.g., the Internet). The user computer device 60 may be in communication with multiple remote (external) data sources represented by 70a, 70b, 70c, and 70d, via the network 50.

The user computer device 60 may have one or more modules configured to perform one or more of the functions described herein. The modules may comprise one or more program modules (e.g., program modules 42 of FIG. 1) executed by the user computer device 60. In embodiments, the user computer device 60 includes on one or more of a location module 61, a display management module 62, a user interest module 63, a prioritization module 64 and an event tracking module 65. In embodiments, the location module 61 is configured to determine the location of the user computer device 60 or another computing device associated with the location of a user. In aspects, the display management module 62 is configured to determine a display (e.g., layout, number, and type of apps, widgets, information, etc. displayed) of the user computer device 60. In embodiments, one or more light sensors 67 are in communication with the display management module 62 and are configured to provide light data to the display management module 62. In aspects, the user interest module 63 is configured to gather and analyze communication data or other sources of context data to determine a user's interest level in different topics or subject matter categories, and store the user interest data in a knowledge database 66. In embodiments, the prioritization module 64 is configured to analyze the user interest data, default element display settings, and real-time event data received by the user computer device 60, and determines a temporary display priority for one or more elements. As used herein, the term element means an icon, widget, app or other information configured to be displayed on a display of a user computer device (e.g. user computer device 60). In aspects, the display management module 62 also updates a display of the user computer device 60 to display one or more elements based on the temporary display priority determined by the prioritization module 64. In embodiments, the user computer device 60 is enabled to gather context data, determine user interest levels in a plurality of subject matter areas, and temporarily re-arrange a display of elements on a display of the user computer device 60. In embodiments, the event tracking module 65 tracks particular topics or subject matter categories of interest to the user in real-time based on user interest data, and provides real-time event data to the user computer device 60.

In embodiments, the user computer device 60 is in communication with a cognitive display server 80 through the network 50. The cognitive display server 80 may comprise the components of the computer system 12 of FIG. 1. The cognitive display server 80 may be configured as a special purpose computing device that is part of a service provider's infrastructure. For example, cognitive display server 80 may be configured to retrieve and analyze context data of users, and provide users with relevant context data upon request.

Still referring to FIG. 2, the cognitive display server 80 may have one or more modules configured to perform one or more of the functions described herein. The modules may comprise one or more program modules executed by the cognitive display server 80. In embodiments, the cognitive display server 80 includes a user interest module 81 configured to gather and analyze communication data or other sources of context data for multiple users to determine each user's interest level in different topics or subject matter categories, and store the user interest data in a knowledge database 82. The cognitive display server 80 may gather context data from one or more remote (external) data sources, such as the data sources 70a-70d depicted in FIG. 2. Remote data sources 70a-70d may provide any desirable type of context data to the cognitive display server 80, such as communications data (email data, social media data, etc.) or real-time event data (e.g., sports data, weather data, mapping data, etc.). In aspects, the cognitive display server 80 includes a prioritization module 83 configured to: analyze the user interest data, default element display settings for a particular user computer device (e.g., 60), and real-time event data received by the cognitive display server 80, and determine a temporary display priority for one or more elements to be displayed on the particular user computer device; and send the temporarily display priority to the particular user computer device to be implemented by the particular user computer device. In embodiments, the event tracking module 84 tracks particular topics or subject matter categories of interest to the user in real-time based on user interest data, and provides the real-time event data to the cognitive display server 80. In aspects, the event tracking module 84 provides the real-time event data to the user computer device 60.

In some embodiments, the user computer device 60 generates user interest data and analyzes the user interest data along with real-time event data and default element display priority data to determine a temporary display priority for one or more elements to be displayed by the user computer device 60. In alternative embodiments, the user computer device 60 obtains user interest data generated by the cognitive display server 80, and analyzes the received user interest data, along with received real-time data and default element display priority data, to determine a temporary display priority for one or more elements to be displayed by the user computer device 60. In additional embodiments, the user computer device 60 obtains the temporary display priority determined by the cognitive display server 80 and implements changes to elements displayed by the user computer device 60 based on the received temporary display priority. It should be understood that systems of the present invention may utilize additional or fewer components and modules than those illustrated in FIG. 2. For example, any single module may be implemented as multiple modules, or multiple modules shown may be implemented as a single module.

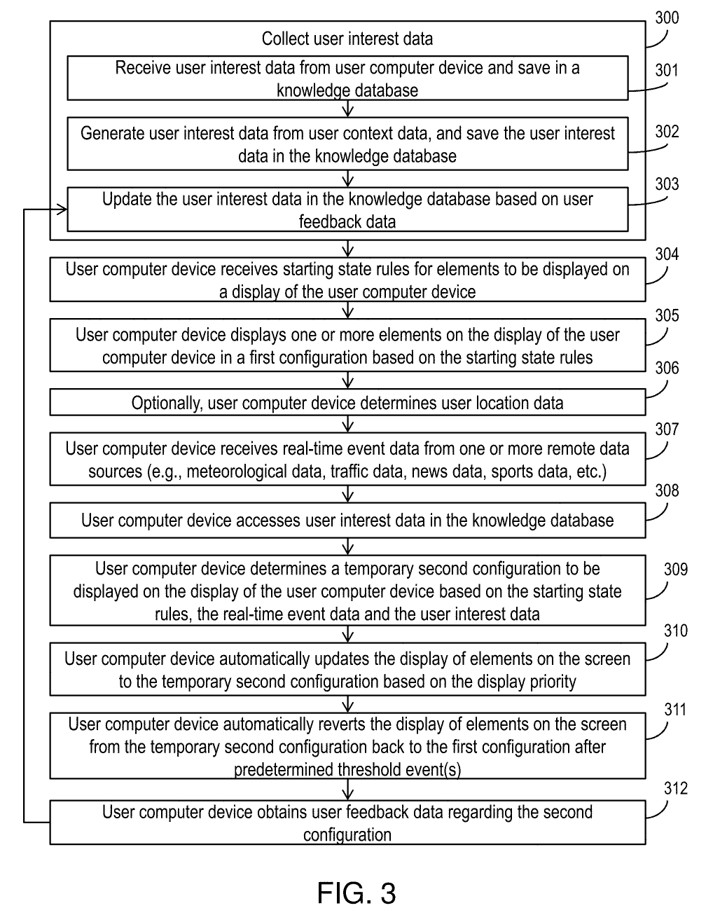

FIG. 3 shows a flowchart of a method in accordance with aspects of the invention. Steps of the method of FIG. 3 may be performed in the environment illustrated in FIG. 2, and are described with reference to elements shown in FIG. 2.

At step 300, user interest data is collected by at least one of the user computer device 60 and the cognitive display server 80. As user herein, user interest data refers to data indicating a user's interest level (priority level) with respect to one or more topics or subject matter categories. For example, the user interest data may indicate a user's varying levels of interest with respect to the following subject matter categories: a sports team; outdoor activities; and travel to Paris. In embodiments, user interest data is collected by the user interest module 63 of the computer device 60 and stored in the knowledge database 66. In embodiments, user interest data is collected by the cognitive display server 80 and stored in the knowledge database 82. In aspects of the invention, the user interest data (including a user's likes and current topics of interest) is stored in an accessible cloud-based database (e.g., knowledge database 82 of the cognitive display server 80) configured to be accessed by the user computer device 60 during the processing of data in accordance with step 309 of FIG. 3 discussed below. Various methods of data analysis may be utilized to determine a user's interest level in a subject matter category for generating user interest data.

At substep 301, the user computer device 60 and/or the cognitive display server 80 receives user interest data directly from the user, such as in the form of answers to a query. For example, the user computer device 60 may present a query to a user regarding the user's interest level in a variety of subject matter categories, and may utilize the user's answers to the query to determine user interest level data. Alternatively, the cognitive display server 80 may send a query through the network 50 to the user computer device 60, and the user computer device 60 may send a user's answers to the query back to the cognitive display server 80 through the network 50, and use the answers to determine user interest level data.

At substep 302, the user computer device 60 and/or the cognitive display server 80 analyze user communication data or other forms of context data to generate user interest data, which is then saved to one of the respective knowledge databases 66 or 82. The user computer device 60 and the cognitive display server 80 may each receive one or more streams of context data from one or more remote data sources (e.g., 70c), such communications data from email, calendar or social networking sources. The user computer device 60 and the cognitive display server 80 may utilize natural language processing (NLP) of the context data to classify a user's sentiment and/or interest level that a user is showing in a particular event or set of events, and use the classification to generate user interest data.

In aspects, the user interest module 63 of the user computer device 60 is utilized to generate the user interest data. In embodiments, the user computer device 60 receives one or more streams of context data from one or more remote data sources, such as a source of communications data (e.g., 70c), which may include a remote calendar data source, email data source, or social networking data source. Text recognition software and/or sentiment recognition software of the user computer device 60 may be utilized to identify subject matter categories of interest in the context data (e.g., emails, social media postings, etc.) of the user. In alternative embodiments, the user interest module 81 of the cognitive display server 80 is utilized to generate the user interest data. For example, text recognition software and/or sentiment recognition software of the cognitive display server 80 may be utilized to identify subject matter categories of interest in the context data (e.g., emails, social media postings, etc.) of the user.

In embodiments, a user has the capability to configure communications data to be utilized by the cognitive display server 80, such as when the user's electronic calendar system may be accessed and read by the cognitive display server 80. Accordingly, the cognitive display server 80 may be configured to obtain user ID and password information from a user for those data sources the user wishes the cognitive display server 80 to access. For example, the user may supply a link to read his or her calendar and tell the cognitive display server 80 how to determine a priority calendar entry (either by specific text added to the entry or by a priority or “importance” indicator (e.g., check box) in the calendar system. In embodiments, the user may enable the cognitive display server 80 to access the user's social network sites for posts associated with his or her user name. In embodiments, the cognitive display server 80 is configured to read in streams of communication data of a user (e.g., from a social network site) at predetermined times in a data gathering cycle, analyzes the data for involvement from the user, and capture data regarding topics or subject matter categories that the user has indicated that they like or that they have indicated an interest in (e.g., topics conversed on). In subsequent cycles, the cognitive display server 80 may start analyzing the streams of data starting with an entry following a time stamped input it last read and continuing through the rest of the entries.

In one exemplary scenario, a social contact of a user posts about Baseball Team X winning a game on a social network site, and the user “likes” the post. Thus, the user has indicated an interest in the subject matter category of “Baseball Team X”, and at a broader level, in the subject matter category of “baseball”, and the cognitive display server 80 can derive user interest data from this interest. In this scenario, the cognitive display server 80 saves derived user interest data in the knowledge database 82, along with associated date and time data (e.g., date and time user interest data was recorded, or date and time user expressed interest in the subject matter categories of “Baseball Team X” and “baseball”). If the user later responds to the post of the user's social contact with the comment “I am so happy Baseball Team X are in the playoff hunt”, the cognitive display server 80 may utilize NLP and classification techniques in order to understand the subject of the post, as well as the subject and sentiment of the user's comment. In this case, the cognitive display server 80 may save derived user interest data in the knowledge database 82, along with date and time data. In this scenario, user interest data stored in the knowledge database 82 may accumulate to show an increasing interest by the user in the subject matter categories “Baseball Team X” and “baseball”.

Still referring to FIG. 3, at substep 303, user feedback data is utilized by the user computer device 60 and/or the cognitive display server 80 to update user interest data. For example, if the user computer device 60 or the cognitive display server 80 recognize an increasing interest by a user in a particular subject matter category based on statistics of user interest data accumulating in one of knowledge databases 66, 82, the user computer device 60 or the cognitive display server 80 may send an inquiry to the user regarding their interest in the subject matter category. Utilizing the example of “Baseball Team X”, the user computer device 60 or cognitive display server 80 may ask the user if the user would like baseball scores for Baseball Team X displayed in real-time, and may further ask the user to indicate a priority level for such displaying (e.g., very important, somewhat important, not important). In another example, the user computer device 60 or the cognitive display server 80 recognizes an increasing interest by a user in Sports Team X only during a Playoff Event, and sends an inquiry to the user regarding their interest in following Sports Team X during the Playoff Event. Additional methods of utilizing user feedback data will be discussed in more detail below with respect to step 312.

At step 304, the user computer device 60 receives starting state rules for elements to be displayed on the display (e.g., 24) of the user computer device 60. As used herein, the term starting state rules means rules regarding the manner in which elements should be displayed by the user computer device 60. The starting state rules may include priority scores or other priority level information dictating the order and/or manner in which the elements are displayed to a user. Starting state rules may be received from a remote source (e.g., cognitive display server 80), may be received from a user directly through an interface of the user computer device 60, or may be received from a combination of sources. In embodiments, one or more elements may be associated with a rule to “always display” the one or more elements, while other elements may be indicated as “maneuverable”. Starting state rules may also include priority scores or other priority level information for one or more subject matter categories associated with the elements. For example, event data associate with the score of a baseball game in which Sports Team X is playing may be set as temporarily high priority during a game and up to one hour after the game, or however the user sees fit to configure such an event. In embodiments, the user computer device 60 is configured to accept information from a received drag and drop priority list including specific orders of relevance/priority applied to known apps.

At step 305, the user computer device 60 displays one or more elements available for display on a display (e.g., 24 of FIG. 1) of the user computer device 60 in a first configuration, based on the starting state rules. As used herein, the term first configuration denotes a configuration of elements including the number of elements shown, the type of elements shown, and/or the manner in which the elements are displayed.

At step 306, the user computer device 60 determines user location data. In embodiments, user location data is determined utilizing the location module 61 of the user computer device 60. The location module 61 may utilize any number of location determining techniques, such as global position system (GPS) techniques. In aspects, the user computer device 60 obtains user location information from another computing device. For example, the user computer device 60 may be a laptop computer and a smartphone of the user (not shown) may send location information data obtained by the smartphone to the laptop computer via the network 50.

At step 307, the user computer device 60 receives real-time event data from one or more remote data sources (e.g., 70a, 70b, 70d). As used herein, the term real-time event data refers to real-time data associated with or pertinent to one or more topics or subject matter categories of interest to a user of the user computer device 60. For example, the real-time event data may comprise meteorological or weather data, traffic data, news data, sports data, airline or other travel data, etc. In one example, the user computer device 60 receives real-time event data from the data source 70a comprising the current score in a sporting event. In another example, the user computer device 60 receives real-time event data from the data source 70b in the form of a weather alert. It should be understood that real-time event data that may be utilized in accordance with embodiments of the invention is not limited to the examples provided herein. In embodiments, the event tracking module 65 of the user computer device 60 is configured to track and receive real-time event data from one or more remote data sources (e.g., 70a, 70b, 70d) based on user interest data recorded in the knowledge database 66.

In certain embodiments, the event tracking module 84 of the cognitive display server 80 is be configured to track and receive real-time event data based on user interest data stored in the knowledge database 82. For example, the cognitive display server 80 may be part of a service infrastructure configured to track particular events in real-time, such as sporting events in progress or other events associated with subject matter categories of interest to the user, and provide pertinent real-time event data to the user computer device 60.

At step 308, the user computer device 60 accesses user interest data in either the knowledge database 66 of the user computer device 60, or the knowledge database 82 of the cognitive display server 80. In embodiments, the cognitive display server 80 provides user interest data as a service to the user computer device 60.

At step 309, the user computer device 60 determines a temporary second configuration for elements to be displayed on the display of the user computer device 60, based on the starting state rules received at step 304, the real-time event data received at step 307, and the user interest data accessed at step 308. In embodiments, the temporary second configuration is based on: a new priority of elements determined based on the starting state rules, the real-time event data and the user interest data, a new configuration of elements determined based on the priority of the elements (temporary new priority of elements and the typical or default priority of elements), the configuration of the display of the user computer device 60 (e.g., size of display and specifications), and any rules determining resizing of elements in the starting state rules (e.g., an element can be shrunk or enlarged by a predetermined amount). In embodiments, the prioritization module 64 of the user computer device 60 determines the temporary display priority for elements to be displayed in accordance with step 309. The temporary display priority may be stored and associated with predetermined threshold event data indicating when the temporary display priority should end.

At step 310, the user computer device 60 automatically updates the display of elements on the screen from the first configuration based on the starting state rules, to the temporary second configuration determined at step 309. In aspects, the display management module 62 updates the display of elements on the screen of the user computer device 60. In embodiments, the temporary second configuration is displayed for a predetermined time period, which may be a set time period or a time period associated with an end event (e.g., the end of a sporting event).

At step 311, the user computer device 60 automatically reverts the display of elements on the display of the user computer device 60 from the temporary second configuration back to the first configuration after a predetermined threshold event is met. In embodiments, the predetermined threshold event is a predetermined time period or the end of an event associated with real-time event data received. For example, the predetermined threshold event may be the expiration of 15 minutes, or may be the end of a sporting event associated with a temporary priority app being displayed by the user computer device 60 in the temporary second configuration.

At step 312, the user computer device 60 may obtain user feedback data regarding the temporary second configuration. In aspects, the user computer device 60 obtains user feedback data based on a user's interaction with the one or more elements displayed in the second display configuration. For example, the user computer device 60 may monitor the use of elements assigned a temporary high priority at step 309 to determine if the user is actually utilizing or accessing the elements. In this example, if the user computer device 60 automatically updates a display of elements on a screen of the user computer device 60 to include an element showing real-time score updates for a game of Sports Team X, then the user computer device 60 may determine if the user is selecting or otherwise accessing the element. If the user computer device 60 determines that the user never accesses the element showing real-time score updates for a games of Sports Team X, then the user computer device 60 may determine that the user is not interested in real-time score updates of Sports Team X, and may update the user interest data in the knowledge databases 66 and/or 82, accordingly.

In embodiments, the user computer device 60 and/or the cognitive display server 80 knows a user's location at all times (e.g., using location data obtained at step 306) and can collect information about local weather at any time. In embodiments of the invention described above, knowledge about a user is known to the system, either through initial configuration (e.g., show Sports Team X score only when they are playing) or through context data input and accepted suggestions from the system (e.g., system noticed a love for Sports Team X and decides to suggest a game tracking app to display during game times, and the user has accepted this as a high priority). A variety of real-time events may be monitored in accordance with embodiments of the invention. For example a system of the present invention may ping a local weather service every 15 minutes or so in order to determine weather events. In embodiments, impending natural disasters may be automatically designated as a high priority alert and an associated weather app (element) may be given the highest priority level possible. For example, if a tornado is forming, the system may automatically classify the tornado event as important and display as such prevalently on the user's computer device (e.g., 60) using a weather app or the like during a time of possible emergency. In this case, to make room for this information, one or more other elements (e.g., app icons) might be temporarily removed, such as an app lower on the priority scale (e.g., a fitness app showing the number of steps taken by a user). Another event may come in such as by way of a time-to-time pinging of real-time sports events (e.g., Sports Team X is playing a day game). In one scenario, the user is sitting at work, and the system determines to place the score for Sports Team X on the user's smartwatch (e.g., user computer device 60) in lieu of the fitness app, which would have a lower interest to the user when the user is sitting at work.

It can be understood that any number of real-time events may impact the manner in which a user may wish to access data via the user computer device 60. Real-time event scenarios may include, for example: when a user is going to the airport (as determined by his location/destination information or a calendar entry), a flight status element and/or any possible news for the airport would become higher priority to the user; when a user is heading to the beach for a long weekend, the 5 day weather forecast becomes more important to the user; and when a user is going out in a boat, the hourly weather forecast or marine forecast becomes more important to the user.

In embodiments, a system of the present invention periodically reads the user's configured electronic calendar for important events and thus determine not only priority events, but also outdoor events which would invoke the weather apps as a priority. In aspects, priority meeting events are shown on a smartwatch or other user computer device 60 up until the time of the meeting or until the user decides to delete the temporary priority meeting event element from the display. In either case, the original information (first configuration) which was displayed by the smartwatch is now displayed again. In embodiments, outdoor events may invoke a display of a 5 day forecast or an hourly forecast or a marine forecast, etc.

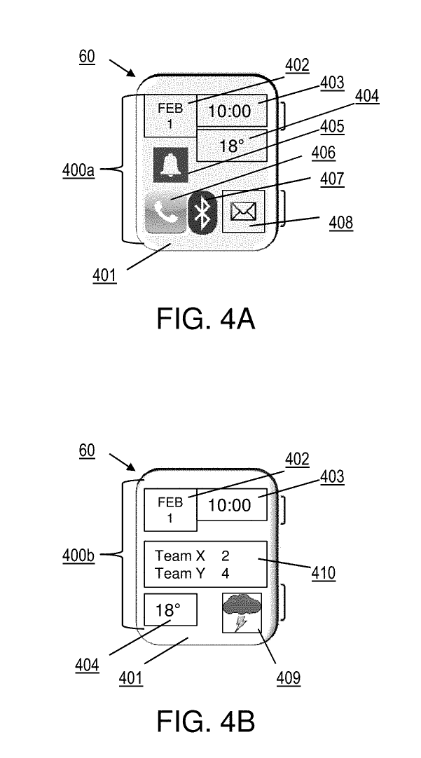

FIGS. 4A and 4B illustrate a particular use scenario in accordance with embodiments of the invention. More specifically, FIG. 4A illustrates a user computer device 60 in the form of a smartwatch, displaying a first configuration of elements 400a on a display 401 based on starting state rules in accordance with step 305 of FIG. 3; and FIG. 4B illustrates the user computer device 60 displaying a temporary second configuration 400b on the display 401 in accordance with step 310 of FIG. 3.

In the use scenario of FIGS. 4A and 4B, the user computer device 60 initially displays the first configuration of elements 400a as shown in FIG. 4A, in accordance with step 305 of FIG. 3. The first configuration of elements 400a includes elements 402-408. The user computer device 60 determines user location data in accordance with step 306 of FIG. 3. In this scenario, the user computer device 60 determines that the user is likely out of doors based on the location data of the user (derived from GPS data and map data). The user computer device 60 then receives real-time data from remote data sources 70a and 70b in accordance with step 307 of FIG. 3. In this exemplary scenario, the real-time data is in the form of real-time score data for a sporting event between Team X and Team Y from remote data source 70a, and a meteorological alert from remote data source 70b indicating that a severe weather event is approaching the user's location. Typically, sports scores are not a priority for the user. Likewise, the weather is not typically a priority for the user. The starting state rules of the user computer device 60 reflect the user's priority preference, such that the user computer device 60 does not display any elements in the first configuration 400a that are associated with weather or sporting events.

The user computer device 60 accesses user interest data stored in the knowledge database 82 of the cognitive display server 80 in accordance with step 308 of FIG. 3. In accordance with step 309 of FIG. 3, the user computer device 60 determines a temporary display priority for elements to be displayed on the display 401 based on the starting state rules, the real-time event data from remote data sources 70a and 70b, and the user interest data in the knowledge database 82. In this scenario, the user interest data indicates that the user has little interest in the weather when the user is indoors, or when the user is outdoors and the weather is mild, but has a great interest in the weather when the user is outdoors and the weather is bad. The user computer device 60 determines that a weather alert element 409 should be displayed as a temporary priority element based on the received real-time meteorological alert data. In this scenario, the user interest data also indicates that the user has a high interest in sporting event scores in which Team X is participating. The user computer device 60 determines that a sports score element 410 should be displayed based on the received real-time score data.

With reference to FIG. 4B, the user computer device 60 automatically updates the display 401 of the user computer device 60 to display the temporary second configuration 400b of elements on the display 401, which is different from the first configuration 400a (of FIG. 4A) and includes the weather alert element 409 and the sports score element 410. More specifically, the user computer device 60 recognizes that the weather alert element 409 and the sports score element 410 should have a temporary high priority based on the real-time event data received (according to step 307 of FIG. 3) and the user interest data accessed (according to step 308 of FIG. 3), and determines the temporary second configuration 400b (according to step 309 of FIG. 3) based on: determining a new priority of elements, determining a new configuration of elements based on the priority of the elements (temporary priority and typical priority of elements), the configuration of the display 401 (e.g., size of display and specifications), and any rules determining resizing of elements in the starting state rules (e.g., an element can be shrunk or enlarged by a predetermined amount). In this scenario, the screen 401 of the user computer device 60 does not include enough space to show all of the elements 402-410, so the user computer device 60 automatically drops the lowest priority elements 405-408 shown in the first configuration 400a, re-arranges the elements 402-404, and adds the temporary high priority elements 409 and 410 to produce the temporary second configuration 400b.

In this scenario, the user computer device 60 later determines that the sporting event in which Team X is participating is over, and also determines that the severe weather event is also over, based on additional real-time event data received in accordance with step 307 of FIG. 3. Based on this additional real-time event data, the user computer device 60 determines that the predetermined threshold events have been met with respect to temporary priority elements 409 and 410, and the user computer device 60 reverts the display 401 back to the first configuration 400a. Thus, it can be understood that embodiments of the invention provide a user with a first set of priority elements (first configuration 400a) to be displayed when there are no ongoing real-time events of particular interest to a user, and provides a user with an unlimited amount of different sets of priority elements (e.g., second configuration 400b) to be displayed based any combination of ongoing real-time events of particular interest to the user.

In embodiments of the invention, the color scheme, illumination level or style of the display skin of the user computer device 60 is changed to make the display more viewable to a user given the precise environment of the user. In aspects, a system of the invention is configured to determine GPS locations and mapping data, and use weather services data to determine the sun's brightness in order to adjust the color scheme or illumination level of the display. In embodiments, the system of the invention is configured to use mapping services data to understand whether the user is indoors or outdoors, to determine specifically what building a user may be in, and to determine whether any building the user may be in is associated with special rules to automatically adjust the device skin (e.g., illumination and color scheme).

In accordance with embodiments of the invention, the skin of a display may be automatically changed by the user computer device 60 based on one or more external factors, such as brightness of the sun (or other lighting) or the precise environment of a user. The term skin as used herein means markup language style sheets that make up the look and feel of a final display by describing a manner in which data is to be represented on the display of the user computer device 60. In embodiments, the user computer device 60 maps the location of a user computer device 60 to discover not only the location of the user, but also what type of building the user may be in, if any, (e.g., dark theater, library, outside at the beach, etc.), and combines this location data with weather data in order to determine the exact current conditions experienced by a user, and adjust the skin of the user computer device 60 accordingly. For example, the user computer device 60 may determine that the user is in a movie theater, and based thereon, the display management module 62 may automatically dim the final screen presentation so as to not intrude on or distract other patrons. The associated colors of the final screen may change as well, as determined by an expert in usability, for example (e.g., the user of the colors black and red are known to be useful for minimal light leakage and may be utilized when patronizing a movie theater). In another example, it is known that in bright outdoor lighting situations, such as the beach, the display of a computer device should not utilize sky-color shading's. Accordingly, embodiments of the invention may utilize black on white or white on dark green color shadings when the user is determined to be in such bright outdoor lighting situations.

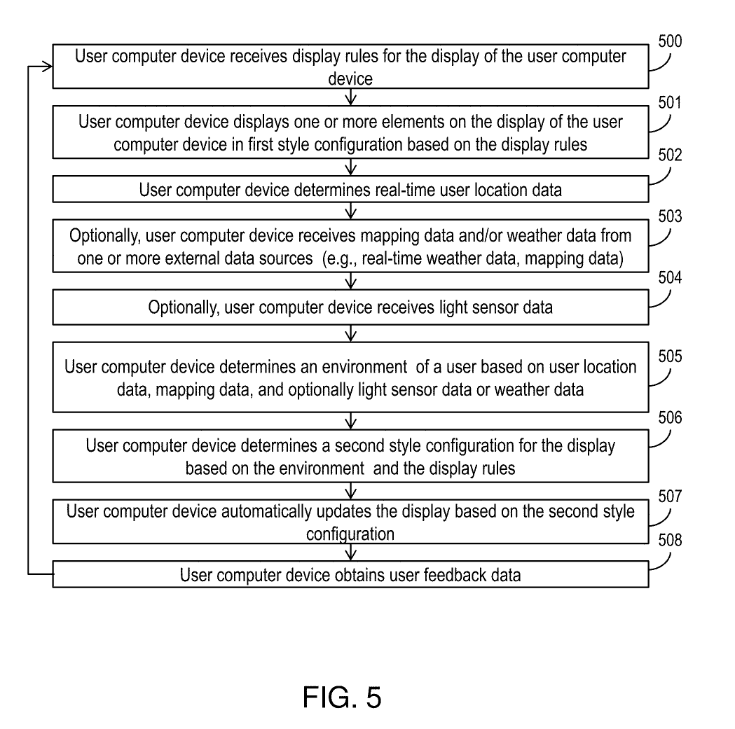

FIG. 5 shows a flowchart of steps of a method in accordance with aspects of the invention. Steps of the method of FIG. 5 may be performed in the environment illustrated in FIG. 2, and are described with reference to elements shown in FIG. 2. For ease of reference, FIG. 5 will be discussed with reference to the user computer device 60 of FIGS. 4A and 4B.

At step 500, the user computer device 60 receives display rules for the display 401. In aspects, the display rules include default display rules and/or initial display rules. In embodiments, display rules include rules regarding the color, style and illumination level of a device display for one or more use scenarios. In embodiments, one or more use scenarios include one or more venue or environment types (e.g., inside a movie theatre, outside at the beach, etc.). Display rules of step 500 may be incorporated with or received at the same time as the starting state rules received at step 304 in FIG. 3.

At step 501, the user computer device 60 displays one or more elements (e.g., 402-408 of FIG. 4A) in a first style configuration. In aspects, the first style configuration is a default configuration based on display rules received at step 500. The term style configuration as used herein means the appearance of the display with respect to color, style, and brightness (illumination) level. In embodiments, the style configuration is automatically updated to provide a display that is easier for a user to view, or is more appropriate given a particular environment or venue of a user, as will be discussed below with respect to steps 502-508.

At step 502, the user computer device 60 determines real-time user location data. In embodiments, user location data is determined utilizing the location module 61 of the user computer device 60. The location module 61 may utilize any number of location determining techniques, such as global position system (GPS) techniques. In aspects, the user computer device 60 obtains user location information from another device. For example, the user computer device 60 may be a laptop computer and a smartphone of the user (not shown) may send location information data obtained by the smartphone to the laptop computer via the network 50. It should be understood that the step 502 of determining user location data may be the same as step 306 of FIG. 3.

At step 503, the user computer device 60 receives mapping data and/or weather data from one or more remote data sources (e.g., 70b, 70d). In aspects, the user computer device 60 receives weather data from a remote weather resource 70b. In embodiments, the user computer device 60 receives mapping data from a remote mapping resource 70d. It should be understood that step 503 may be the same as step 307 of FIG. 3 (i.e., receiving real-time event data from one or more remote/external data sources).

At step 504, the user computer device 60 receives light sensor data from one or more light sensors 67 of the user computer device 60. In embodiments, the user computer device 60 determines the ambient lighting at the user computer device 60 based on the light sensor data (e.g., ambient lighting is low, normal or bright).

At step 505, the user computer device 60 determines an environment (e.g., venue) of a user based on user location data, mapping data, and optionally, light sensor data and/or weather data. In embodiments, the display management module 62 determines an environment in accordance with step 505. The term environment as used herein means a particular environment of a user in context of their immediate surroundings, such as indoors, outdoors, in a movie theatre, in a parking garage, etc. Thus, it can be understood that the term environment refers to the immediate surroundings and context of the surroundings of a user, not simply geographic coordinates. In embodiments, the user computer device 60 compares location data from a GPS of the user computer device 60 (e.g., location module 61) with mapping data from a remote mapping data source (e.g., 70d) to determine an environment of a user. In embodiments, the user computer device 60 compares location data from a GPS of the user computer device 60 (e.g., location module 61) with mapping data stored in a database of the user computer device 60. For example, the user computer device 60 may compare GPS coordinates of the user computer device with mapping data to determine that the user's position is likely within a movie theatre. In another example, the user computer device 60 may compare GPS coordinates of the user computer device with mapping data to determine that the user's position is likely outside at the beach.

In embodiments, the user computer device 60 also utilizes weather data obtained from a remote weather data source (e.g., 70b) to determine the environment of the user. For example, the user computer device 60 may receive weather data indicating that the weather is sunny at the location of the user (e.g., based on GPS coordinates from the location module 61), and may also determine, based on comparing mapping data to the location of the user, that the user is likely outside at the beach. Thus, the user computer device 60 would determine that the environment of the user is outside at the beach in the sunshine.

At step 506, the user computer device 60 determines a second style configuration for the display 401 based on the environment determined at step 505 and display rules received at step 500. In aspects, the display management module 62 of the user computer device 60 makes the determination in accordance with step 506. In embodiments, the user computer device 60 determines the second style configuration by comparing the environment determined at step 505 with a look-up table of display rules to determine a match between the environment and a predetermined style configuration. By way of example, the user computer device 60 may determine that the environment of a movie theatre determined at step 505 is associated with a style configuration in the display rules wherein the brightness of the display 401 is at its lowest setting. This darker screen style configuration is represented graphically in FIG. 4A. By way of another example, the user computer device 60 may determine that the user is outside at night, based on a time of day (nighttime) and the location of the user being outside of any buildings according to mapping data. In this example, the user computer device 60 may determine that the outside nighttime environment is associated with a style configuration in the display rules wherein the brightness of the display 401 is at its highest setting. This brighter screen style configuration is represented graphically in FIG. 4B.

At step 507, the user computer device 60 automatically updates the display 401 based on the second style configuration determined at step 506. In embodiments, the display management module 62 of the user computer device 60 automatically updates the display 401 of the user computer device 60. In embodiments, the second style configuration is a temporary style configuration associated with the particular environment determined at step 505 of FIG. 5.

At step 508, the user computer device 60 obtains user feedback data. In embodiments, the user feedback data obtained at step 508 may be utilized to update display rules received at step 500. In this way, embodiments of the invention may learn from preferences of a user to provide better style configurations for particular environments. By way of example, a user in a movie theatre may decide that the second style configuration that is automatically provided by the user computer device 60 is not bright enough. In the case where the user adjusts the display 401 while in the second style configuration, the user computer device 60 may recognize the change as user feedback data and make an adjustment to the display rules such that future visits to the movie theatre by the user will result in a style configuration on the display 401 which is brighter than the original brightness setting for the second style configuration.

Some benefits of the present invention can be appreciated by comparing two tasks: (1) sitting in a movie theater; and (2) walking home at night. In both situations, a user computer device (e.g., 60) would be able to determine, based on sensor data received from an ambient light sensor, that the user was in a dark environment. In a first scenario where a style configuration is adjusted based only on the light sensor data, the user computer device either brightens or darkens the screen based on the low light conditions, but not both. In a second scenario utilizing techniques of the present invention, the user computer device 60 receives sensor data from one or more light sensors 67 and determines that the user is in a dark environment. However, the user computer device 60 also utilizing mapping data to determine a specific environment of the user. For example, if the user computer device 60 determines that a user is within a movie theatre, then rules associated with movie theatres are accessed and the user computer device 60 determines that the screen brightness should be at its very lowest (so as not to disturb other moviegoers). Conversely, if the user computer device 60 determines that the user is outside in a dark environment, then rules associated with outdoor environments are accessed and the user computer device 60 determines that the screen brightness should be increased to be brighter (so as to enable a user to navigate by the light of the device). Thus, embodiments of the present invention advantageously enable automatic screen display adjustments based on specific user environments, not just ambient light conditions.

In performing the steps of FIG. 5, whether it is bright out or cloudy may be known by the user computer device 60 based on user location data, map data and weather data received from a remote weather service. In embodiments, map data will allow the user computer device 60 to determine if the user is on a beach or on a ski slope (e.g., during winter) by correlating GPS location data to known maps through the use of mapping services (thus the user computer device 60 understands that the user's environment is even brighter due to the reflection of the snow or sand). In aspects, the invention is configured to automatically adjust the illumination, colors and style of a display based on time of day (day, dusk, dawn, night), amount of clouds and other brightness factors. Certain colors are known to work better under bright conditions, and certain colors are known to work better under dark conditions, for example. Associated illumination changes would also apply. Conversely, while indoors, weather may be irrelevant to the FIG. 5 method. However, GPS location data correlated to known maps through the use of mapping services is utilized to determine environment. For example, the GPS location may correlate with a movie theatre in mapping data, indicating that the user is in a movie theatre and the display 401 should be adjusted accordingly (e.g., reduce brightness to avoid bothering other patrons).

A computer-implemented method of implementing embodiments of FIG. 5 may comprise: displaying, by the computing device, a first style configuration of a display based on display rules; determining, by the computing device, an environment of the user; and automatically updating, by the computing device, the display from the first style configuration to a second style configuration based on the environment of the user and the display rules. In aspects, the method may further comprise receiving data selected from the group consisting of mapping data and weather data. In embodiments, the determining the environment is based on user location data and mapping data. In aspects, the determining the environment is further based on data selected from the group consisting of light sensor data and weather data. In embodiments, the method may further comprise obtaining user feedback data and updating the display rules based on the user feedback data.

In embodiments, steps of FIG. 3 may be combined with steps of FIG. 5 to provide automatic updates to both the configuration of elements (e.g., first and second configurations of FIG. 3) and the style configuration (e.g., first and second style configurations of FIG. 5). By way of example, the user computer device 60 may determine a display priority for elements to be displayed on the display 401 in accordance with step 309 of FIG. 3, and simultaneously determine the second skin for the display based on the user's environment in accordance with step 506 of FIG. 5. Thereafter, the user computer device 60 may simultaneously automatically update the display 401 to display the second configuration of display elements in accordance with step 310 of FIG. 3, and automatically update the display 401 to display the second style configuration in accordance with step 507 of FIG. 5.

In embodiments, a service provider could offer to perform the processes described herein. In this case, the service provider can create, maintain, deploy, support, etc., the computer infrastructure that performs the process steps of the invention for one or more customers. These customers may be, for example, any business that uses mobile device technology. In return, the service provider can receive payment from the customer(s) under a subscription and/or fee agreement and/or the service provider can receive payment from the sale of advertising content to one or more third parties.

In still another embodiment, the invention provides a computer-implemented method for automatic cognitive adjustment of display content. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
displaying on a display, by a computing device, a first configuration of elements from a group of elements configured to be displayed on the computing device based on starting state rules;
receiving, by the computing device, real-time event data from one or more remote data sources, wherein the real-time event data is associated with one or more categories of interest to a user;
accessing, by the computing device, user interest data prioritizing the categories of interest to the user;
determining, by the computing device, a temporary second configuration of elements from the group of elements based on the starting state rules, the real-time event data and the user interest data; and
automatically updating, by the computing device, the display to display the second configuration of elements, wherein the temporary second configuration of elements is different from the first configuration of elements.

2. The method of claim 1, further comprising receiving, by the computing device, the starting state rules.

3. The method of claim 1, further comprising determining, by the computing device, user location data, wherein the determining the temporary second configuration of elements is based in part on the user location data.

4. The method of claim 1, wherein the real-time event data includes at least one selected from the group consisting of: meteorological data; traffic data; news data; and sports data.

5. The method of claim 1, wherein the accessing the user interest data comprises accessing the user interest data in a database of a remote server.

6. The method of claim 1, further comprising automatically reverting, by the computing device, the display to display the first configuration of elements upon determining that a predetermined threshold event is met.

7. The method of claim 1, further comprising:
obtaining, by the computing device, user feedback regarding the second configuration; and
updating, by the computing device, the user interest data based on the user feedback.

8. The method of claim 1, further comprising:
displaying, by the computing device, a first style configuration of the display based on display rules;
determining, by the computing device, an environment of the user; and
automatically updating, by the computing device, the display from the first style configuration to a second style configuration based on the environment of the user and the display rules.

9. The method of claim 1, further comprising receiving, by the computing device, at least one of the group consisting of: user location data; mapping data; and weather data.

10. The method of claim 9, wherein the determining the environment of the user is based on the user location data and the mapping data.

11. The method of claim 10, wherein the determining the environment is further based on at least one of the group consisting of: light sensor data and the weather data.

12. A computer program product for automatic cognitive adjustment of display content, the computer program product comprising a computer readable storage medium having program instructions embodied therewith, the program instructions executable by a computing device to cause the computing device to:
receive starting state rules for a group of elements configured to be displayed by the computing device;
display, on a display screen, a first configuration of elements from the group of elements based on the starting state rules;
receive real-time event data from one or more remote data sources, wherein the real-time event data is associated with one or more categories of interest to a user;
access user interest data at a remote server, wherein the user interest data prioritizes the categories of interest to the user;
determine a temporary second configuration of elements from the group of elements based on the starting state rules, the real-time event data and the user interest data; and
automatically update the display screen to display the second configuration of elements, wherein the temporary second configuration of elements is different from the first configuration of elements.

13. The computer program product of claim 12, wherein the program instructions further cause the computing device to determine user location data, wherein the determining the temporary second configuration of elements is based in part on the user location data.

14. The computer program product of claim 12, wherein the real-time event data includes at least one selected from the group consisting of: meteorological data; traffic data; news data; and sports data.

15. The computer program product of claim 12, wherein the program instructions further cause the computing device to automatically replace the display of the second configuration of elements with the first configuration of elements upon determining that a predetermined threshold event is met.

16. The computer program product of claim 12, wherein the program instructions further cause the computing device to:
obtain user feedback regarding the second configuration; and
update the user interest data based on the user feedback.

17. The computer program product of claim 12, wherein the program instructions further cause the computing device to:
display a first style configuration of the display based on display rules;
determine an environment of the user based on user location data and mapping data; and
automatically update the display from the first style configuration to a second style configuration based on the environment of the user and the display rules.

18. A system for automatic cognitive adjustment of display content, comprising:
a CPU, a computer readable memory and a computer readable storage medium associated with a computing device;
program instructions to display, on a display screen of the computing device, a first configuration of elements based on starting state rules;
program instructions to receive real-time event data from one or more remote data sources, wherein the real-time event data is associated with one or more categories of interest to a user;
program instructions to access user interest data, wherein the user interest data prioritizes the categories of interest to the user;
program instructions to determine a temporary second configuration of elements based on the starting state rules, the real-time event data and the user interest data; and
program instructions to automatically update the display screen to temporarily display the second configuration of elements until a predetermined threshold event is met, wherein the temporary second configuration of elements is different from the first configuration of elements;
wherein the program instructions are stored on the computer readable storage medium for execution by the CPU via the computer readable memory.

19. The system of claim 18, further comprising:
program instructions to display a first style configuration of the display based on display rules;
program instructions to determine an environment of the user based on user location data and mapping data; and
program instructions to automatically update the display from the first style configuration to a second style configuration based on the environment of the user and the display rules.

20. The system of claim 19, wherein the program instructions to determine the environment of the user is further based on one or more data selected from the group consisting of light sensor data and weather data.
